(19) United States
(12) Patent Application Publication
(10) Pub. No.: US 2019/0307214 A1
(43) Pub. Date: Oct. 10, 2019

(54) Illuminated Ring

(71) Applicant: Joseph Vinci, Saugus, CA (US)

(72) Inventor: Joseph Vinci, Saugus, CA (US)

(21) Appl. No.: 16/367,463

(22) Filed: Mar. 28, 2019

Related U.S. Application Data
(60) Provisional application No. 62/653,098, filed on Apr. 5, 2018.

(51) Int. Cl. A44C 15/00; A44C 9/00; F21V 23/04; F21V 21/08

(52) U.S. Cl. CPC A44C 15/0015; F21V 21/08; F21V 23/0414; A44C 9/0053

(57) ABSTRACT

An illuminated ring. The illuminated ring includes an annular member having an exterior surface opposite an interior surface, wherein a first plurality of lights are disposed on the exterior surface. A second plurality of lights are disposed across an upper surface of the annular member, oriented perpendicularly to the first plurality of lights. A switch disposed on the exterior surface, the switch operably connected to each of the first plurality of lights and the second plurality of lights such that the switch can toggle each of the first plurality of lights and the second plurality of lights between an activated state and a deactivated state.

### CROSS REFERENCE TO RELATED APPLICATIONS

This application claims the benefit of U.S. Provisional Application No. 62/653,098 filed on Apr. 5, 2018. The above identified patent application is herein incorporated by reference in its entirety to provide continuity of disclosure

### BACKGROUND OF THE INVENTION

The present invention relates to ring jewelry. More particularly, the present invention pertains to rings having a several light sources thereon, such that a user can illuminate the surrounding area.

Many people struggle to see in low light conditions, which causes difficulty in a variety of activities, such as unlocking a door, finding specific objects when searching through a container, such as a purse or bag, or reading. While many people have access to flashlights or mobile devices with flashlight applications, it can still be difficult to find such flashlights in low light conditions. Furthermore, a flashlight or mobile device must be held, often leading to frustration when a user is required to carry multiple objects. Therefore, a device allowing a user to have a hands-free light source readily available at all times is desired.

In light of the devices disclosed in the known art, it is submitted that the present invention substantially diverges in design elements from the known art and consequently it is clear that there is a need in the art for an improvement to existing illuminated rings. In this regard, the instant invention substantially fulfills these needs.

### SUMMARY OF THE INVENTION

In view of the foregoing disadvantages inherent in the known types of illuminated rings now present in the known art, the present invention provides an illuminated ring wherein the same can be utilized for providing convenience for the user when providing omni-directional lighting in low-light conditions, such as the interior of containers.

The present system comprises an annular member having an exterior surface opposite an interior surface, wherein a first plurality of lights are disposed on the exterior surface. A second plurality of lights are disposed across an upper surface of the annular member, oriented perpendicularly to the first plurality of lights. A switch is disposed on the exterior surface, the switch operably connected to each of the first plurality of lights and the second plurality of lights. The switch is configured to toggle each of the first plurality of lights and the second plurality of lights between an activated state and a deactivated state. In some embodiments, the switch is further configured to adjust an intensity of each of the first plurality of lights and the second plurality of lights. In another embodiment, each of the first plurality of lights and the second plurality of lights are configured to selectively move between a pair of preset intensity levels. In other embodiments, an ornamental feature is disposed on the exterior surface, opposite the switch. In yet another embodiment, the first plurality of lights comprise a pair of lights disposed on opposing sides of the switch. In some embodiments, the second plurality of lights are disposed at even intervals along the upper surface. In another embodiment, a third plurality of lights are disposed along a lower surface of the annular member, the third plurality of lights operably connected to the switch. In other embodiments, the third plurality of lights are disposed at even intervals along the lower surface. In yet another embodiment, the switch is configured to adjust an intensity of the third plurality of lights. In some embodiments, the third plurality of lights is configured to selectively move between a pair of preset intensity levels. In another embodiment, the third plurality of lights are opposite and aligned with the second plurality of lights.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the illuminated ring.

FIG. 2 shows a close-up view of the switch of an embodiment of the illuminated ring.

FIG. 3A shows a top plan view of an embodiment of the illuminated ring.

FIG. 3B shows a bottom plan view of an embodiment of the illuminated ring.

### DETAILED DESCRIPTION OF THE INVENTION

Reference is made herein to the attached drawings. Like reference numerals are used throughout the drawings to depict like or similar elements of the illuminated ring. The figures are intended for representative purposes only and should not be considered to be limiting in any respect.

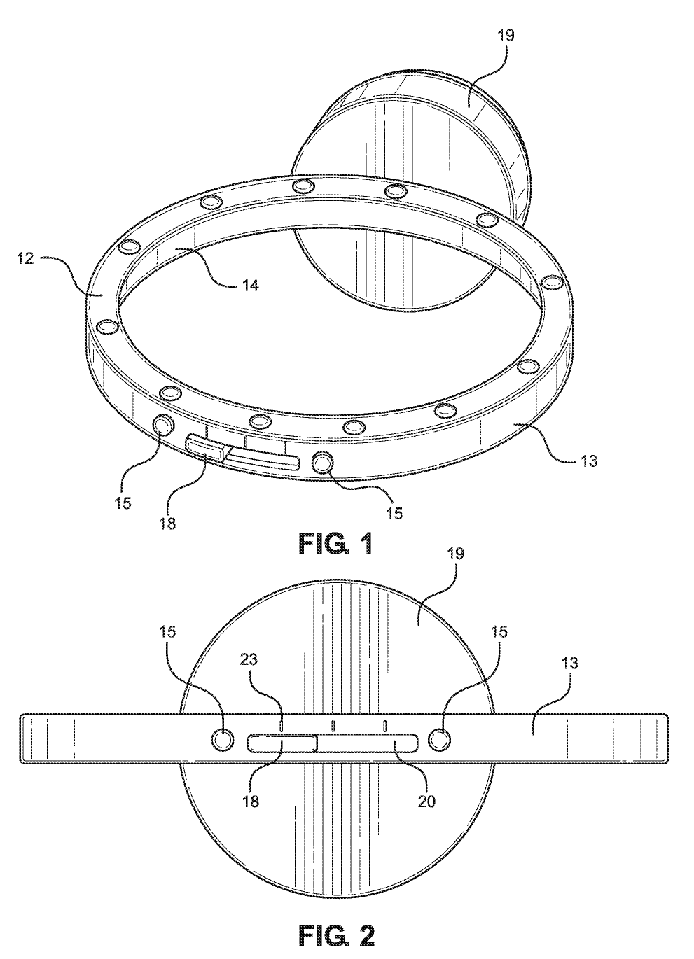

Referring now to FIG. 1, there is shown a perspective view of an embodiment of the illuminated ring. The illuminated ring 11 comprises an annular member 12 having a central aperture configured to receive a finger of a user therethrough such that the annular member 12 is secured to the user via friction fit. The annular member 12 further comprises an interior surface 14 opposite an exterior surface 13, wherein the interior surface 14 is configured to rest flush against the finger when the illuminated ring 11 is in use. A switch 18 is disposed on the exterior surface 13, wherein the switch 18 is operably connected to an internal power source disposed within the annular member 12 and a first plurality of lights 15. In this way, the switch 18 is configured to selectively activate and deactivate the first plurality of lights 15. In the illustrated embodiment, the annular member 12 further comprises an ornamental feature 19 disposed on the exterior surface 13, the ornamental feature 19 directly opposite the switch 18. In this way, the user can easily index the illuminated ring 11, allowing the user to simply position the switch 18 on an interior side of a finger. This allows a user to camouflage the illuminated ring 11 as a traditional piece of jewelry for everyday use.

Referring now to FIG. 2, there is shown a close-up view of the switch of an embodiment of the illuminated ring. The switch 18 is positioned along the exterior surface 13 such that a user can operate the switch 18 with a thumb of the hand wearing the illuminated ring. In the illustrated embodiment, the switch 18 comprises a slider switch having a plurality of set positions therealong. In some embodiments, the switch 18 is configured to illuminate the first plurality of lights 15 at a first position and increase the intensity of illumination of the first plurality of lights 15 at a second position. In this way, the user can easily toggle the first plurality of lights 15 between a low intensity level and a high intensity level according to the current illumination needs of the user. For example, the first plurality of lights 15 may be illuminated to increase visibility within a specific container, such as a purse or backpack, however, should the level of illumination not be sufficient, the user can toggle the first plurality of lights 15 to the high intensity level to further increase visibility in low-light conditions. In the illustrated embodiment, the switch 18 further comprises indicia 23 disposed therealong, wherein the indicia 23 are configured to indicate the various settings for the first plurality of lights 15. For example, in the illustrated embodiment, three indicia 23 appear, indicating a deactivated state, low-intensity activated state, and high-intensity activated state, respectively. In the shown embodiment, the indicia 23 comprise hash marks along the switch 18, however alternate markings are also contemplated, including text labels.

In the illustrated embodiment, the first plurality of lights 15 are disposed on opposing ends 20 of the switch 18, such that light emitted therefrom is evenly dispersed across the rear of the illuminated ring. In this way, a user can easily direct the light emitted from the first plurality of lights 15 in a desired direction, while the dispersed nature of the first plurality of lights 15 allows a user to minimize potential obstructions thereto. In some embodiments, the first plurality of lights 15 are disguised by surface ornamentation, thereby allowing the first plurality of lights 15 to blend in with the exterior surface 13, or otherwise be camouflaged as decorative elements, such that the illuminated ring appears a traditional ring jewelry.

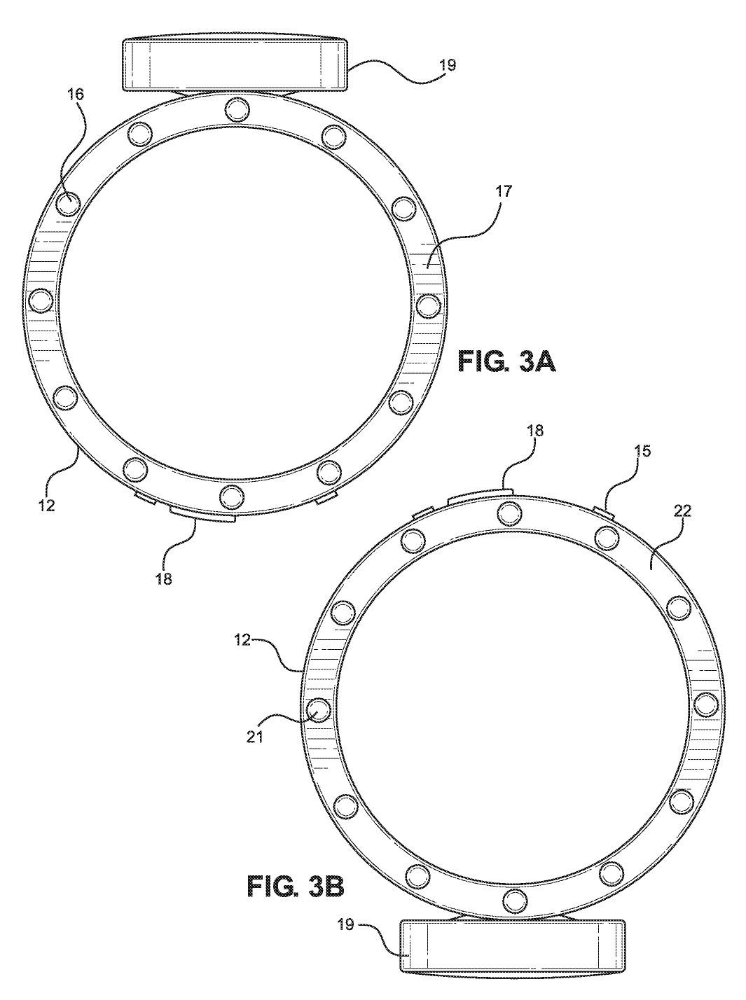

Referring now to FIGS. 3A and 3B, there are shown a top plan view of an embodiment of the illuminated ring and a bottom plan view of an embodiment of the illuminated ring, respectively. In the illustrated embodiments, the annular member 12 further comprises a second plurality of lights 16 disposed across an upper surface 17 of the annular member 12, and a third plurality of lights 21 disposed across a lower surface 22 of the annular member 12. The second and third plurality of lights 16, 21 are operably connected to the switch 18, such that the switch 18 is configured to selectively move the second and third plurality of lights 16, 21 between an activated state and a deactivated state. Similar to the operation of the first plurality of lights 15, the second and third plurality of lights 16, 21 can be, in some embodiments, selectively moved between a low intensity level and a high intensity level to vary the illumination provided thereby for a particular scenario. In the illustrated embodiments, each of the first, second, and third plurality of lights 15, 16, 21 are simultaneously activated via actuation of the switch 18, while in alternate embodiments, each of the first, second, and third plurality of lights 15, 16, 21 are independently connected to a separate switch 18.

In the illustrated embodiments, the second and third plurality of lights 16, 21 are evenly distributed along the upper and lower surfaces 17, 22, respectively, such that light emitted therefrom is distributed evenly from the annular member 12. In this way, the illuminated ring can provide consistent light from each direction, allowing a user to easily direct light to a desired area. In some embodiments, the second and third plurality of lights 16, 21, are spaced at regular intervals along the upper and lower surfaces 17, 22, respectively. In other embodiments, the second and third plurality of lights 16, 21 are positioned opposite each other, such that each light of the second plurality of lights 16 is aligned with a light of the third plurality of lights 21, ensuring that light emitted from either side of the annular member 12 is equal and opposite, providing even distribution and concentration thereof. In this way, the illuminated ring is reversible, allowing a user to wear the illuminated ring with either the lower surface 22 facing towards a hand of the user, or away from the hand, without impeding functionality of the illuminated ring. In some embodiments, the second and third plurality of lights 16, 21 are disguised as gem settings or other ornamental features, thereby allowing the illuminated ring to more thoroughly mimic traditional ring jewelry.

In one exemplary use, the user places the annular member 12 over a desired finger, such that the finger extends through the central aperture. The annular member 12 is then positioned such that any ornamental feature 19 is facing an exterior of the hand, thereby allowing the switch 18 to be positioned on the interior of the hand, such that he user can operate the switch 18 with a thumb of the same hand. When greater visibility is required in low-light conditions, the user can actuate the switch, thereby illuminating at least the first plurality of lights 15 to increase visibility. Should greater visibility be required, the user can further actuate the switch 18 to increase the intensity of the light emitted by the first plurality of lights 15, The user can then easily direct the emitted light in a desired direction to illuminate the surrounding area.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An illuminated ring, comprising:
an annular member having an exterior surface opposite an interior surface, wherein a first plurality of lights are disposed on the exterior surface;
a second plurality of lights disposed across an upper surface of the annular member, oriented perpendicularly to the first plurality of lights;
a switch disposed on the exterior surface, the switch operably connected to each of the first plurality of lights and the second plurality of lights;
wherein the switch is configured to toggle each of the first plurality of lights and the second plurality of lights between an activated state and a deactivated state.

2. The illuminated ring of claim 1, wherein the switch is further configured to adjust an intensity of each of the first plurality of lights and the second plurality of lights.

3. The illuminated ring of claim 2, wherein each of the first plurality of lights and the second plurality of lights are configured to selectively move between a pair of preset intensity levels.

4. The illuminated ring of claim 1, further comprising an ornamental feature disposed on the exterior surface, opposite the switch.

5. The illuminated ring of claim 1, wherein the first plurality of lights comprise a pair of lights disposed on opposing sides of the switch.

6. The illuminated ring of claim 1, wherein the second plurality of lights are disposed at even intervals along the upper surface.

7. The illuminated ring of claim 1, further comprising a third plurality of lights disposed along a lower surface of the annular member, the third plurality of lights operably connected to the switch.

8. The illuminated ring of claim 7, wherein the third plurality of lights are disposed at even intervals along the lower surface.

9. The illuminated ring of claim 7, wherein the switch is further configured to adjust an intensity of the third plurality of lights.

10. The illuminated ring of claim 9, wherein the third plurality of lights are configured to selectively move between a pair of preset intensity levels.

11. The illuminated ring of claim 7, wherein the third plurality of lights are opposite and aligned with the second plurality of lights.
